(19) United States
(12) Patent Application Publication
(10) Pub. No.: US 2005/0018059 A1
(43) Pub. Date: Jan. 27, 2005

(54) Imaging device and control method thereof

(75) Inventor: Tomoyuki Mizuta, Saitama (JP)

Correspondence Address: MCGINN & GIBB, PLLC, 8321 OLD COURTHOUSE ROAD, SUITE 200, VIENNA, VA, 22182-3817, US

(73) Assignee: Fuji Photo Film Co., Ltd., Minami-Ashigara-Shi (JP)

(21) Appl. No.: 10/896,025

(22) Filed: Jul. 22, 2004

(30) Foreign Application Priority Data
Jul. 25, 2003 (JP) 2003-279920

(51) Int. Cl. H04N 5/262

(52) U.S. Cl. 348/239

(57) ABSTRACT

A high sensitive image signal output from a main pixel and a low sensitive image signal output from a sub pixel are input to an image signal processing circuit. A composite parameter which is changed in response to setting conditions of image quality is input to an image composite processor from a system controller. The image composite processor generates a composed image signal by composing the high and low sensitive image signals based on the composite ratio designated by the composite parameter.

### BACKGROUND OF THE INVENTION

1. Field of the Invention

The present invention relates to an imaging device, and more particularly to an imaging device in which compsite ratios of a main output signal from a main pixel and a sub output signal from a sub pixel are set in response with an image-quality setting, and a control method of the imaging device.

2. Description of the Related Arts

There is a widespread use of a digital camera in which an object image formed through an image pickup optical system is taken by a solid state image sensor and image data generated from an analog signal from the solid state image sensor is recorded in a memory.

The solid state image sensor outputs the analog signal corresponding to accumulated signal charge after converting photoelectrically the object light in each pixel. However, since there are limits to charge accumulation capacity in each pixel, the analog signal exceeding a saturation level of each pixel cannot be obtained. Accordingly, a dynamic range of the solid state image sensor is narrow.

For example, in the solid state image sensor disclosed in Japanese Patent Laid-Open Publication No. 9-205589, for the purpose of widening the dynamic range of the solid state image sensor, a pixel is constituted of a main pixel having high sensitivity and a sub pixel having low sensitivity and a large dynamic range. The image data is generated by composing output signals output respectively from the main and the sub pixels. In the case of the digital still camera using such a solid state image sensor, a composed image having enough graduation width in each brightness range is obtained by composing the output signals from the main and the sub pixels at a predetermined ratio. However, even if it is possible to change the image quality of the composed image, for example to give preference to the sensitivity or gradation expression, by changing the composite ratio, the image quality cannot be widely changed. If a function for changing the composite ratio is provided in the digital still camera, it is difficult to use for a user without the expert knowledge.

### SUMMARY OF THE INVENTION

An object of the present invention is to provide an imaging device including a composite ratio changing circuit for changing composite ratios of a main output signal from a main pixel and a sub output signal from a sub pixel in response with adjustment of image quality.

In order to achieve the above object, the composite ratios of the main and the sub output signals from the main and the sub pixels are changed in response with adjustment of an image quality controller.

In a preferable embodiment of the present invention, the image quality controller is provided with image quality adjustment items including sensitivity setting and exposure correction. When the plural image quality adjustment items are set simultaneously, the composite ratios of the main and the sub output signals are changed in response to such multiple settings. If the sensitivity is set at a low sensitive side, the composite ratio for the sub output signal becomes high, while if it is set at a high sensitive side, the composite ratio for the main output signal becomes high. If the exposure correction is performed to a plus side, the composite ratio for the sub output signal becomes high, while if it is performed to a minus side, the composite ratio for the main output signal becomes high.

According to the present invention, the composite ratios of the main and the sub output signals are changed in response with the sensitivity setting and the exposure correction, so that the image quality can be changed widely. In addition, a user without expert knowledge of photographing can change the composite ratios of the main and the sub output signals only by adjusting the image quality.

### BRIEF DESCRIPTION OF THE DRAWINGS

The above and other subjects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1A is a front perspective view of a digital still camera to which the present invention is applied;

FIG. 1B is a rear perspective view of the digital still camera;

FIG. 2 is a block view showing a constitution of the digital still camera;

FIGS. 3A, 3B, 3C and 3D are explanatory views showing a display monitor on which image quality adjustment items are displayed;

FIG. 4 is a plan view of a light-receiving surface of a solid state image sensor;

FIG. 5 is a graph showing a signal level of an image signal to an exposure amount;

FIG. 6 is a block view showing a constitution of an image signal processing circuit;

FIG. 7 is a graph showing kinds of composed image signals; and

FIG. 8 is a flow chart of an image-taking process.

### DETAILED DESCRIPTION OF THE PREFERRED EMBODIMENTS

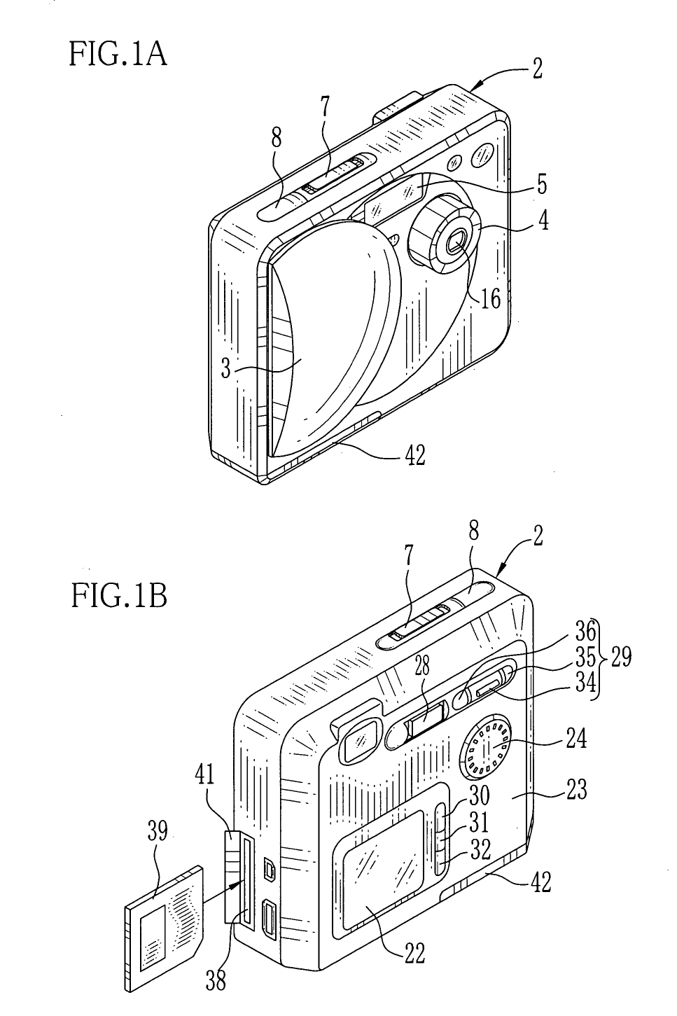

In FIGS. 1A and 1B, a slidable lens cover 3 having an approximately semicircular shape is attached to a front surface of a digital still camera 2. The lens cover 3 is slid to a closed position in the right direction of the drawing when the digital still camera 2 is non-used condition or in a reproduction mode, in order to cover the front surface of the digital still camera 2. When photographing, the lens cover 3 is slid to an open position in a left direction of the drawing to expose a lens barrel 4, a flash emitter 5 and so forth.

There are a power source operating member 7 operated slidably in the left to right direction and a shutter button 8 depressed in up and down directions in a top surface of the digital still camera 2. A power switch 9 is incorporated under the power source operating member 7 and operated to turn on/off the power source of the digital still camera 2 according to the operation of the power source operating member 7.

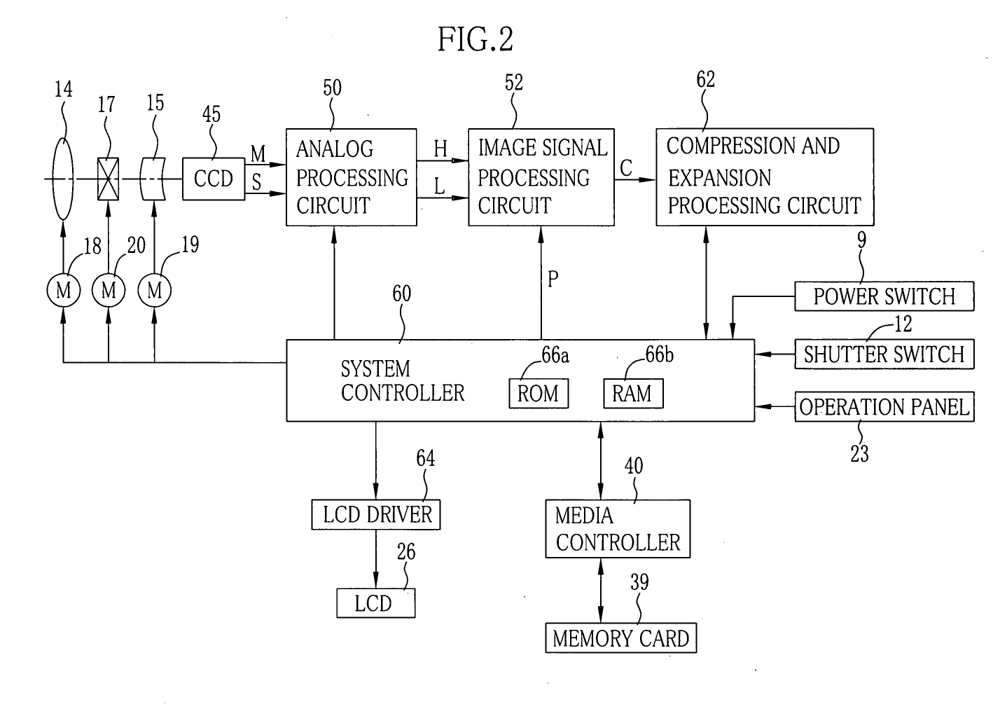

As shown in FIG. 2, a shutter switch 12 depressed in two steps is incorporated under the shutter button 8. When the first step of the shutter switch 12 is on after pushing lightly the shutter button 8, an auto-focusing function and automatic exposure function are actuated to perform focusing and exposure setting. Subsequently, a shutter release is executed after the second step of the shutter switch 12 has been on by depressing the shutter button 8 more deeply.

If the power source of the digital still camera 12 is turned on in the taking mode, the lens barrel 4 collapsed into a camera body is extended forward. A taking lens 16, which is constituted of a zoom lens 14 and a focus lens 15 for example, and an aperture stop mechanism 17 are incorporated in the lens barrel 4. The zoom lens 14, the focus lens 15 and the aperture stop mechanism 17 are driven by motors 18, 19 and 20 having a driver circuit. The zoom motor 18 is also used as a driving source for collapsing and extending of the lens barrel 4.

A display monitor 22, an operation panel 23 and an audio output unit 24, which is constituted of a speaker, are incorporated in a rear surface of the digital still camera 2. The display monitor 22 for reproducing the taken image data is constituted of a color LCD panel 26 and also used as a viewfinder at the time of photographing.

The operation panel 23 is constituted of a mode operation member 28, a cross key 29, a cancel button 30, a menu button 31 and a display button 32. The mode operation member 28 can be slid in the left and right directions. A mode switch, which outputs an operation signal in response to the slide position of the mode operation member 28, is incorporated therebehind. The digital still camera 2 is switched to a moving image taking mode for taking a moving image, a reproducing mode for reproducing a taken still image or moving image, or a still image taking mode for taking the still image by the sliding operation for the mode operation member 28.

The cross key 29 is constituted of an up-and-down lever 34 operated swingably in the up and down directions and left and right buttons 35, 36 disposed on each side of the up-and-down lever 34. The up-and-down lever 34 and the left and right buttons 35, 36 are used when a cursor and a selection frame displayed on the display monitor 22 are moved in the up, down, left and right directions. In addition, the up-and-down lever 34 is used for a zooming operation upon taking and reproducing, while the left and right buttons 35, 36 are used for a frame feeding upon reproducing. Switches turned on/off by the up-and-down lever 34 and the left and right buttons 35, 36 are respectively incorporated behind each of them.

The menu button 31 is used when a setting menu corresponding to the presently-set mode is displayed on the display monitor 22, and also used as an OK button for performing the setting change. The cancel button 30 is used when canceling the setting change. The display button 32 is operated to switch on/off in the display monitor 22 in the taking mode, and depressed when the display setting of the display monitor 22 is switched. Switches turned on/off by the cancel button 30, the menu button 31 and the display button 32 are respectively incorporated behind each button.

In the still image taking mode, plural types of setting menus are displayed on the display monitor 22 after depressing the menu button 31. If “image setting” is selected from among these setting menus, adjustment items including “sensitivity”, “brightness”, “color” and “white balance” are displayed on the display monitor 22.

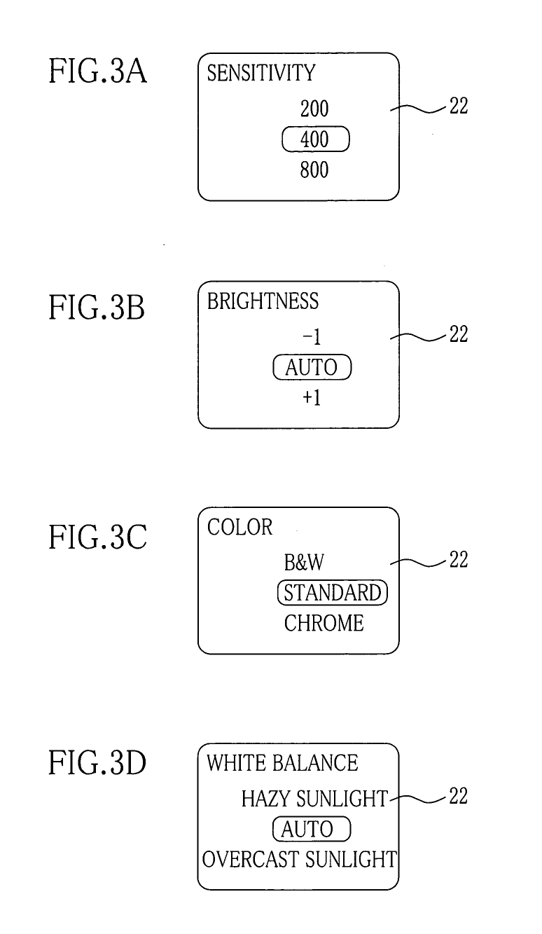

If the “sensitivity” is selected, a taking sensitivity is set as selecting the type of photo film. As shown in FIG. 3A, sensitivity setting values, “200”, “400” and “800” are displayed on the display monitor 22. These sensitivity setting values are diverted from ISO sensitivities of the photo film. As the number becomes larger, the sensitivity becomes higher. Note that the intermediate value “200” is a normal setting in the digital still camera 2 of the present embodiment.

If the “brightness” is selected, a manual correction is given to the exposure value determined automatically in the digital still camera 2. As shown in FIG. 3B, exposure correction values (EV) including “−1”, “AUTO” and “+1” are displayed on the display monitor 22. Note that the “AUTO” showing that the manual correction is not performed is a normal setting in the digital still camera 2 of the present embodiment. Although in an original exposure correction function the exposure correction value can be selected in +0.3 EV steps for example, it is possible to select either −1 EV or +1 EV in the present embodiment for ease of explanation.

If the “color” is selected, contrast, a color tint and so forth of the image data, which is finally produced, are set. As shown in FIG. 3C, setting names for color such as “B&W”, “standard” and “chrome” are displayed on the display monitor 22. If the “B&W” is selected, monochrome image data is obtained. If the “standard” as the normal setting in the digital still camera 2 is selected, the image data having normal contrast and coloration is obtained. If the “chrome” is selected, the image data having high color vividness is obtained since the contrast and the coloration are enhanced.

When the “white balance” is selected, the white balance is adjusted manually by selecting the environment at the time of photographing. As shown in FIG. 3D, setting names such as “fair weather”, “AUTO” and “cloudy weather” are displayed on the display monitor 22. The “fair weather” and “cloudy weather” represent the weather in outdoor photographing. In selecting the “AUTO”, the white balance is adjusted automatically based on object brightness and the like.

A memory card slot 38 opened through a lid member 41 is provided in the side surface of the digital still camera 2. A memory card 39 is inserted therein. A connector electrically connected with the inserted memory card 39 is incorporated behind the memory card slot 38. A media controller 40 for reading and writing the image data in the memory card 39 is connected with the connector. There is a battery container in which a battery as the power source is loaded in the bottom surface of the digital still camera 2. The battery container is covered by an openable battery lid 42.

A CCD solid state image sensor (hereinafter referred to as a CCD) 45 is disposed behind the lens barrel 4. The object image passed through the zoom lens 14 and the focus lens 15 is imaged after being formed on the light-receiving surface of the CCD 45. The CCD 45 converts the imaged object image photoelectrically and then outputs two systems of analog signal. In addition, the CCD 45 is provided with an electronic shutter function for performing a shutter release in response to the operation of the shutter button 8.

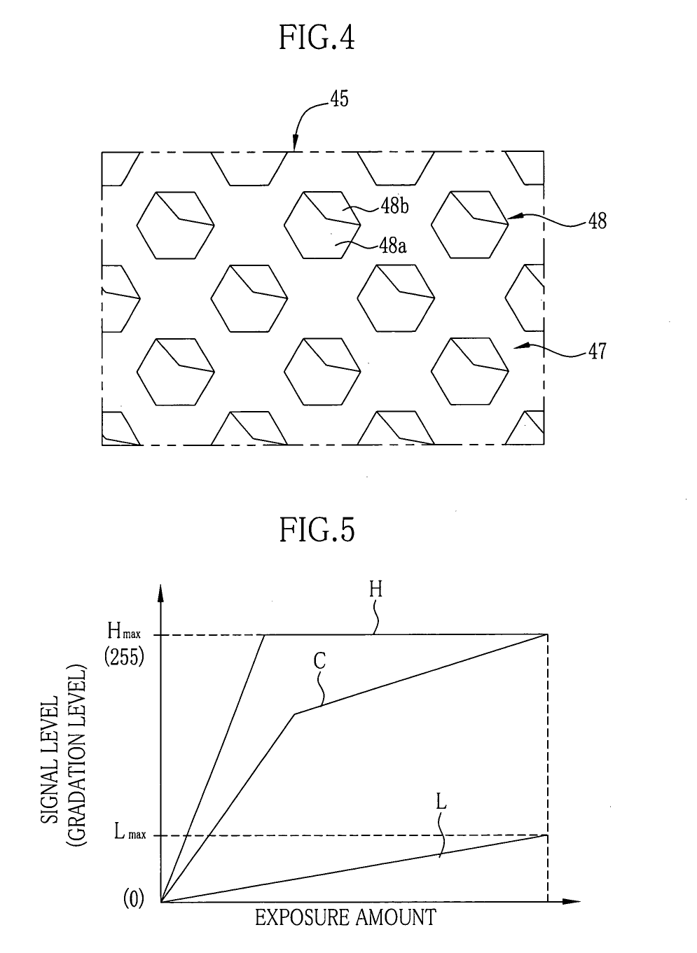

As shown in FIG. 4, plural pixels 48 are arranged two-dimensionally on a light-receiving surface 47 of the CCD 45. Each pixel 48 having a honeycomb structure is constituted of a main pixel 48a and a subpixel 48b of which the light receiving area is smaller than the main pixel 48a. The CCD 45 outputs a main output signal M constituted of the electric charge accumulated in the main pixel 48a and a sub output signal S constituted of the electric charge accumulated in the sub pixel 48b, and then inputs these signals to an analog processing circuit 50.

The analog processing circuit 50 is the so-called analog front-end circuit which is constituted of a CCD driver, a correlation double sampling circuit (CDS circuit), an auto gain controller (AGC) and an A/D converter (ADC) and so forth. The main and the sub output signals M, S are converted to digital signals R, G and B by the analog processing circuit 50 and then input to an image signal processing circuit 52 as a high sensitive image signal H and a low sensitive image signal L.

Signal levels (gradation levels) of the high and the low sensitive image signals H, L to the exposure amount of the CCD 45 are shown in FIG. 5. The signal level Hₘₐₓ saturated by the eight-bit high sensitive image signal H is the gradation level of 255. Since the main pixel 48a reaches the saturation level in a small incident light amount, even if the main pixel 48a has received a light amount, which is larger than the saturation level, the signal level of the high sensitive image signal H does not increase, and also the dynamic range becomes narrow. Meanwhile, although the saturation level Lₘₐₓ of the sub pixel 48b is lower than the main pixel 48a, since the sensitivity of the subpixel 48b to the incident light amount is dull, the dynamic range of the low sensitive image signal L becomes wider.

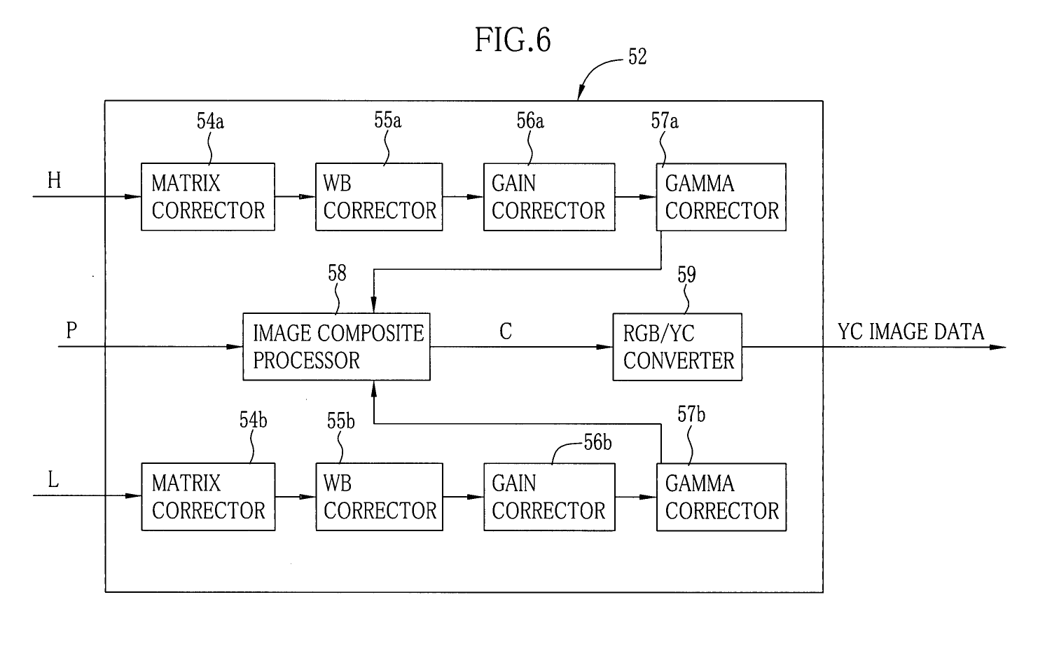

In FIG. 6, two kinds of correction systems including matrix correctors 54a, 54b, white balance (WB) correctors 55a, 55b, gain correctors 56a, 56b, and gamma correctors 57a, 57b are provided in the image signal processing circuit 52 in order to process the high and the low sensitive image signals H, L. The image signal processing circuit 52 is also provided with a RGB/YC converter 59 and an image composite processor 58 for generating a composed image signal C by composing the corrected high and low sensitive image signals H, L.

Firstly, the matrix correctors 54a, 54b respectively perform a hue correction to the high and the low sensitive image signals H, L based on a linear matrix converting equation. Secondly, the WB correctors 55a, 55b respectively adjust the white balance of the high and the low sensitive image signals H, L. Thirdly, the gain correctors 56a, 56b respectively adjust the gain of the high and the low sensitive image signals H, L in response to the sensitivity setting and so forth. Although the white balance correction and the gain correction are performed automatically in the normal setting, it is also possible to perform manually by selecting the abovementioned “image setting”. Lastly, the gamma correctors 57a, 57b respectively perform the gamma correction to the high and the low sensitive image signals H, L after the white balance correction. After the gamma correction, the high and the low sensitive image signals H, L are respectively sent to the image composite processor 58.

The image composite processor 58 composes the corrected high and low sensitive image signals H, L. The two signals H, L are added at a predetermined ratio to generate the composed image signal C of which the gradation level is the same as that of the high sensitive image signal H. Thereby, as shown in FIG. 5, the composed image signal C can obtain the wide dynamic range of which the gradation level is the same as that of the low sensitive image signal L in addition to having a gradation width which is the same as that of the high sensitive image signal H.

In addition, a composite parameter P from the system controller 60 is input to the image composite processor 58. The composite parameter P is a parameter which indicates the ratio for composing the high and the low sensitive image signals H, L to the image composite processor 58. When the abovementioned “sensitivity” and “brightness” are determined, the composite parameter P is changed in response to the setting conditions.

For instance, when the sensitivity is changed from the normal setting value “400” to “800”, the composite ratio for the high sensitive image signal H in the composite parameter P, which has been input to the image composite processor 58, becomes high. Meanwhile, when the sensitivity is changed from “400” to “200”, the composite ratio for the low sensitive image signal L in the composite parameter P becomes high.

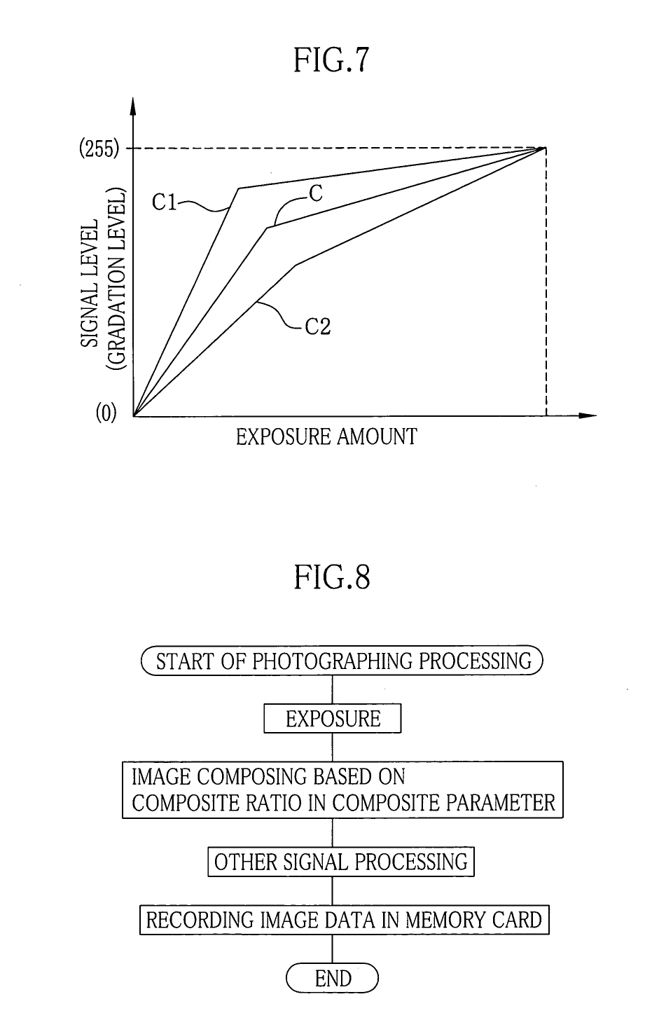

The graph in FIG. 7 shows the composed image signal C changed by the composite parameter P. The composed image signal C is generated by the composite parameter P when the sensitivity is “400”. Meanwhile, composed image signals C1 and C2 are respectively generated by the composite parameters P at the sensitivities of “800” and “200”. As shown in this graph, when the sensitivity is set at a high sensitive side, the sensitivity in a low brightness range in the composed image signal C1 is high. On the other hand, when the sensitivity is set at a low sensitive side, the gradation expression is given preference over the sensitivity in the composed image signal C2.

In addition, when the exposure correction is performed in setting “brightness”, the composite parameter P in which the composite ratio corresponds to the exposure correction value is input to the image composite processor 58. If the exposure correction value “−1” is selected, the composite parameter P in which the composite ratio for the high sensitive image signal H is high is input to the image composite processor 58 to generate the composed image signal approximating the composed image signal C1. Likewise, if the exposure correction value “+1” is selected, the composite parameter P in which the composite ratio for the low sensitive image signal L is high is input to the image composite processor 58 to generate the composed image signal approximating the composed image signal C2.

In the present embodiment, as in the case of changing “sensitivity” or “brightness”, when “color” or “white balance” is changed, the composite parameter P is input to the image composite processor 58 corresponding to each setting condition. Additionally, if the “sensitivity”, “brightness”, “color” and “white balance” are changed simultaneously, it is possible to adjust the image quality effectively in the appropriate composite ratio by preparing the composite parameter P corresponding to the combination of the multiple settings. The composite parameter P in which the composite ratio is appropriate may be obtained by performing calculation processing from the composite parameter P in each setting without preparing the composite parameter P corresponding to the combination of the multiple settings.

The RGB/YC converter 59 converts the composed image signal C constituted of R, G and B to YC image data constituted of brightness data and color-difference data. A compression and expansion processing circuit 62 converts the YC image data into a predetermined file format (e.g. the JPEG format) by compression. The compressed image data is recorded in the memory card 39 by the media controller 40. In the reproducing mode, if the image data in the memory card 39 is reproduced in the display monitor 22, the image data read from the memory card 39 is expanded by the compression and expansion processing circuit 62 and then reproduced in the LCD panel 26 by a LCD driver 64.

The system controller 60 controls the overall operation of the digital still camera 2. The system controller 60 is constituted of a microcomputer for example, and provided with a ROM 66a, in which a control program and various setting data are stored, and a work RAM 66b, in which various data generated upon controlling is temporally stored, in addition to a CPU.

There are two composite parameters P stored in the ROM 66a. One parameter corresponds to the setting condition of the “image setting” menu and the other corresponds to the state that the multiple settings are performed. When the “image setting” menu is changed, the system controller 60 inputs the composite parameter P corresponding to the setting condition to the image composite processor 58 after reading the composite parameter P from the ROM 66a.

Next, the operation of the above embodiment is explained with reference to the flow chart in FIG. 8. When the lens barrel 4 is directed toward the object with holding the digital still camera 2, the image taken by the CCD 45 is through-displayed in the display monitor 22. When the shutter button 8 is pushed in a predetermined timing, an ON-signal from the shutter switch 12 is input to the system controller 60.

The system controller 60 calculates object distance and the exposure value based on the YC image data when the first step of the shutter switch 12 is ON. When the second step of the shutter switch 12 is ON, the aperture stop mechanism 17 and the electronic shutter function of the CCD 45 are actuated according to the exposure value to perform the photographing after the focusing has been performed based on the object distance.

The main output signal M formed by the electric charge accumulated in the main pixel 48a and the sub output signal S formed by the electric charge accumulated in the sub pixel 48b are output from the CCD 45 and then input to the analog processing circuit 50. Subsequently, the main and the sub output signals M, S are input to the image signal processing circuit 52 after being converted into the digital high and low sensitive image signals H, L.

The image signal processing circuit 52 applies the matrix correction, the white balance correction, the gain correction and the gamma correction to the high and the low sensitive image signals H, L and then inputs these signals to the image composite processor 58. The image composite processor 58 composes the high and the low sensitive image signals H, L in the predetermined ratio based on the composite parameter P input from the system controller 60.

If the “image setting” menu is not changed, the normal composed image signal C, which is shown in FIG. 7, is generated by adding the high and the low sensitive image signals H, L at a normal composite ratio. If the high sensitivity “800” is selected in setting the “sensitivity”, the composite ratio for the high sensitive image signal H in the composite parameter P becomes high, so that the composed image signal C1 of which the sensitivity in the low brightness range is high is generated.

Meanwhile, if the low sensitivity “200” is selected, the composite ratio for the low sensitive image signal L in the composite parameter P becomes high, so that the composed image signal C2 to which the gradation expression is given preference is generated.

In case of performing the exposure correction in setting the “brightness”, the composed image approximating the composed image signal C1 or C2 is generated. Also, if the “sensitivity”, “brightness”, “color” and “white balance” are changed simultaneously, the composed image signal is generated in the composite ratio corresponding to the multiple setting changes.

The composed image signal C1 constituted of R, G and B is converted into the YC image data by the RGB/YC converter 59 to be input to the compression and expansion processing circuit 62. The image data converted into the predetermined file format (e.g. the JPEG format) by compression through the compression and expansion processing circuit 62 is recorded in the memory card 39 by the media controller 40.

As aforementioned, since the composite ratio for the high and the low sensitive image signals H, L is changed in response with the image setting, even if the user does not have the expert knowledge of the digital still camera 2, he/she can change the image quality widely only by performing the image setting, and, in addition, the image quality can be improved.

Moreover, only the gain adjustment is performed in the sensitivity setting in a prior digital still camera, so that the image quality has been deteriorated if the sensitivity is set at the high sensitive side. However, in the present invention, since the sensitivity adjustment can be supported by changing the composite ratio for the high and low sensitive image signals H, L, the gain adjustment amount becomes small, so that the image quality in setting at the high sensitivity side can be enhanced. Additionally, since the gradation expression is smoothed in setting at the low sensitivity side, the image quality is improved.

Furthermore, in a prior exposure correction, white voids are occurred when a plus correction is performed, and in addition, white blemish is occurred when a minus correction is performed. However, in the present invention, the composite ratio for the low sensitive image signal L is high in the plus correction, while the composite ratio for the high sensitive image signal H is high in the minus correction. Therefore, it is possible to prevent both the white voids and the white blemish without reducing the effect of the exposure correction.

In addition, in the above embodiment, although there are three kinds of selection items in each image quality adjustment item of “sensitivity”, “brightness”, “color” and “white balance”, the present invention can correspond to more selection items.

Furthermore, in addition to the digital still camera in the above embodiment, any imaging devise in which the solid state image sensor having the main and the sub pixels is used can be applied to the present invention.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. An imaging device comprising:
a solid state image sensor having plural pixels arranged two-dimensionally, each of said pixel being constituted of a main pixel and a sub pixel, which has sensitivity differing from that of said main pixel;
a composite circuit for generating image data by composing a main output signal from said main pixel and a sub output signal from said sub pixel;
an image quality controller for adjusting image quality of said image data; and
a composite ratio changing circuit for changing a composite ratio for said main output signal and said sub output signal in response with adjustment of said image quality controller.

2. An imaging device as claimed in claim 1, wherein said image quality controller is a sensitivity setting device for setting the sensitivity.

3. An imaging device as claimed in claim 1, wherein said image quality controller is an exposure correction device for correcting exposure.

4. An imaging device as claimed in claim 1, wherein said image quality controller includes plural image quality adjustment items.

5. An imaging device as claimed in claim 4, wherein said composite ratio changing circuit changes said composite ratio for said main output signal and said sub output signal in response to multiple settings when said plural image quality adjustment items are set simultaneously.

6. An imaging device as claimed in claim 5, wherein said composite ratio for said sub output signal is high when said sensitivity setting device is set at a low sensitive side, while said composite ratio for said main output signal is high when said sensitivity setting device is set at a high sensitive side.

7. An imaging device as claimed in claim 6, wherein said composite ratio for said sub output signal is high when said exposure correction device is corrected at a plus side, while said composite ratio for said main output signal is high when said exposure correction device is corrected at a minus side.

8. A control method of an imaging device, said imaging device including a solid state image sensor and an image quality controller for adjusting image quality, said solid state image sensor having plural pixels arranged two-dimensionally, each of said pixel being constituted of a main pixel and a sub pixel, which has sensitivity differing from that of said main pixel, said control method comprising the steps of:
changing a composite ratio for a main output signal from said main pixel and a sub output signal from said sub pixel in response with the adjustment of said image quality controller; and
generating image data by composing said main output signal and said sub output signal.

9. A control method as claimed in claim 8, wherein said image quality controller is a sensitivity setting device for setting the sensitivity.

10. A control method as claimed in claim 8, wherein said image quality controller is an exposure correction device for correcting exposure.

11. A control method as claimed in claim 8, wherein said image quality controller includes plural image quality adjustment items.

12. A control method as claimed in claim 11, wherein said composite ratio changing circuit changes said composite ratio for said main output signal and said sub output signal in response to multiple settings when said plural image quality adjustment items are set simultaneously.

13. A control method as claimed in claim 12, wherein said composite ratio for said sub output signal is high when said sensitivity setting device is set at a low sensitive side, while said composite ratio for said main output signal is high when said sensitivity setting device is set at a high sensitive side.

14. A control method as claimed in claim 13, wherein said composite ratio for said sub output signal is high when said exposure correction device is corrected at a plus side, while said composite ratio for said main output signal is high when said exposure correction device is corrected at a minus side.
